(19) United States
(12) Patent Application Publication
(10) Pub. No.: US 2025/0222471 A1
(43) Pub. Date: Jul. 10, 2025

(54) Rotating Sprinkler Device with Movable Track

(71) Applicant: Samuel Sams, Olympia Fields, IL (US)

(72) Inventor: Samuel Sams, Olympia Fields, IL (US)

(21) Appl. No.: 19/013,120

(22) Filed: Jan. 8, 2025

Related U.S. Application Data
(60) Provisional application No. 63/618,553, filed on Jan. 8, 2024.

(51) Int. Cl. B05B 3/04

(52) U.S. Cl. CPC B05B 3/04

(57) ABSTRACT

A rotating sprinkler device with movable track is provided. The device is comprised of a base with a hose connection point, a tubing, and a track to which at least one rotating sprinkler head is attached. As user can connect a hose to the base with the connection point to supply water to the sprinkler head. The sprinkler head can then be slid along the track in order to move the position of the sprinkler head, without moving the base, to water various areas surrounding the device.

### CROSS-REFERENCE TO RELATED APPLICATION

The present application claims priority to, and the benefit of, U.S. Provisional Application No. 63/618,553, which was filed on Jan. 8, 2024, and is incorporated herein by reference in its entirety.

### FIELD OF THE INVENTION

The present invention relates generally to the field of sprinklers. More specifically, the present invention relates to a rotating sprinkler device with a movable track with a base that allows a user to reposition at least one sprinkler head along the base via a track. Accordingly, the present disclosure makes specific reference thereto. Nonetheless, it is to be appreciated that aspects of the present invention are also equally applicable to other like applications, devices, and methods of manufacture.

### BACKGROUND

Watering a lawn can often prove to be a challenging endeavor, particularly when relying on existing sprinkler systems known in the art. These sprinklers come with their own set of limitations, such as restricted coverage provided by the sprinkler heads. Due to this limitation, homeowners or gardeners frequently find themselves having to manually relocate the sprinkler to ensure comprehensive coverage.

This task is not only tedious but can also be inconvenient. The process of dragging and repositioning the hoses often results in individuals inadvertently getting their clothes and footwear wet. Furthermore, if one isn't diligent about consistently moving the hoses to different parts of the lawn, it can lead to uneven watering. This inconsistent distribution of water can then give rise to patchy grass growth, with some areas flourishing while others remain parched and undernourished, which creates an undesirable lawn appearance. Therefore, there exists a long-felt need in the art for an improved sprinkler. There also exists a long-felt need in the art for a rotating sprinkler device with movable track. More specifically, there exists a long-felt need in the art for a rotating sprinkler device with movable track that can more evenly water a lawn. Further, there exists a long-felt need in the art for a rotating sprinkler device with movable track that can more evenly water a lawn by allowing the sprinkler head to be easily moved in order to cover different areas of a lawn.

The subject matter disclosed and claimed herein, in one embodiment thereof, comprises a rotating sprinkler device with movable track. The device is comprised of a base with a hose connection point, a tubing, and a track to which at least one rotating sprinkler head is attached. As user can connect a hose to the base with the connection point to supply water to the sprinkler head. The sprinkler head can then be slid along the track in order to move the position of the sprinkler head, without moving the base, to water various areas surrounding the device.

In this manner, the rotating sprinkler device with movable track of the present invention accomplishes all the forgoing objectives and provides an improved sprinkler. More specifically, the device can more evenly water a lawn via the sprinkler head by allowing the sprinkler head to be easily moved within the base. This allows the sprinkler to be easily repositioned in order to cover different areas of a lawn.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rotating sprinkler device with movable track. The device is primarily comprised of a base with at least one sprinkler head that can be moved within the base via at least one track of the base. As a result, the base can be positioned in one location, but wherein the sprinkler head can be moved within the base to allow different areas of a lawn to be covered.

The base is preferably generally rectangular and is comprised of at least one leg. The base is also comprised of at least one connection point that allows at least one hose to be attached to the base. The connection point is in fluid communication with at least one sprinkler head of the device via at least one internal tubing within the base that runs from the connection point to the sprinkler head.

The sprinkler head attaches to the base via at least one track attached within and/or on the base. The track may be any type of sliding track style that allows the sprinkler head to remove laterally along the X-axis of the base. The sprinkler head is preferably a rotating sprinkler head that can rotate 360 degrees relative to the Y-axis of the base such that the head can be automatically rotated (via water pressure) or manually rotated to water a desired area of a lawn.

The present invention is also comprised of a method of using the device. First, a device is provided comprised of a base with at least one track, at least one connection point, and at least one tubing, and at least one sprinkler head attached to the track. Then, a hose can be attached to the connection point. Then, water can be supplied to the device via the hose, wherein the water travels from the hose, through the connection point and tubing to the sprinkler head, and out of the sprinkler head out to the area surrounding the sprinkler head. Next, the sprinkler head can be repositioned along the track as desired to water various areas of an area surrounding the sprinkler head.

The present invention is also comprised of a method of using the device. First, a device is provided comprised of a base with at least one leg, at least one track, at least one connection point, and at least one tubing, and at least one sprinkler head attached to the track. Then, a hose can be attached to the connection point. Next, a user can adjust the height and/or angle of the leg. Then, water can be supplied to the device via the hose, wherein the water travels from the hose, through the connection point and tubing to the sprinkler head, and out of the sprinkler head out to the area surrounding the sprinkler head. Next, the sprinkler head can be repositioned along the track as desired to water various areas of an area surrounding the sprinkler head.

Accordingly, the rotating sprinkler device with movable track of the present invention is particularly advantageous as it provides an improved sprinkler. More specifically, the device can more evenly water a lawn via the sprinkler head by allowing the sprinkler head to be easily moved within the base. This allows the sprinkler to be easily repositioned in order to cover different areas of a lawn. In this manner, the rotating sprinkler device with movable track overcomes the limitations of existing sprinklers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a rotating sprinkler device with movable track of the present invention while a hose is attached to the device in accordance with the disclosed architecture;

FIG. 2 illustrates a perspective view of one potential embodiment of a rotating sprinkler device with movable track of the present invention with the sprinkler head in various positions along the track in accordance with the disclosed architecture;

FIG. 3 illustrates a flowchart of a method of using one potential embodiment of a rotating sprinkler device with movable track of the present invention in accordance with the disclosed architecture; and

FIG. 4 illustrates a flowchart of a method of using one potential embodiment of a rotating sprinkler device with movable track of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved sprinkler. There also exists a long-felt need in the art for a rotating sprinkler device with movable track. More specifically, there exists a long-felt need in the art for a rotating sprinkler device with movable track that can more evenly water a lawn. Further, there exists a long-felt need in the art for a rotating sprinkler device with movable track that can more evenly water a lawn by allowing the sprinkler head to be easily moved in order to cover different areas of a lawn.

The present invention, in one exemplary embodiment, is comprised of a rotating sprinkler device with movable track primarily comprised of a base with at least one sprinkler head that can be moved within the base via at least one track of the base. As a result, the base can be positioned in one central location and the sprinkler head can be moved within the base to allow different areas of a lawn to be covered.

The base is preferably generally rectangular and is comprised of at least one leg. The base is also comprised of at least one connection point that allows at least one hose to be attached to the base. The connection point is in fluid communication with at least one sprinkler head of the device via at least one internal tubing within the base. The tubing runs from the connection point to the sprinkler head.

The sprinkler head attaches to the base via at least one track attached within and/or on the base. The track may be any type of sliding track style that allows the sprinkler head to remove laterally along the X-axis of the base. The sprinkler head is preferably a rotating sprinkler head that can rotate 360 degrees relative to the Y-axis of the base. In this manner, the head can be automatically rotated (via water pressure) or manually rotated to water a desired area of a lawn.

The present invention is also comprised of a method of using the device. First, a device is provided comprised of a base with at least one track, at least one connection point, and at least one tubing, and at least one sprinkler head attached to the track. Then, a hose can be attached to the connection point. Then, water can be supplied to the device via the hose, wherein the water travels from the hose, through the connection point and tubing to the sprinkler head, and out of the sprinkler head out to the area surrounding the sprinkler head. Next, the sprinkler head can be repositioned along the track as desired to water various areas of an area surrounding the sprinkler head.

The present invention is also comprised of a method of using the device. First, a device is provided comprised of a base with at least one leg, at least one track, at least one connection point, and at least one tubing, and at least one sprinkler head attached to the track. Then, a hose can be attached to the connection point. Next, a user can adjust the height and/or angle of the leg. Then, water can be supplied to the device via the hose, wherein the water travels from the hose, through the connection point and tubing to the sprinkler head, and out of the sprinkler head out to the area surrounding the sprinkler head. Next, the sprinkler head can be repositioned along the track as desired to water various areas of an area surrounding the sprinkler head.

Accordingly, the rotating sprinkler device with movable track of the present invention is particularly advantageous as it provides an improved sprinkler. More specifically, the device can more evenly water a lawn via the sprinkler head by allowing the sprinkler head to be easily moved within the base. This allows the sprinkler to be easily repositioned in order to cover different areas of a lawn. In this manner, the rotating sprinkler device with movable track overcomes the limitations of existing sprinklers known in the art.

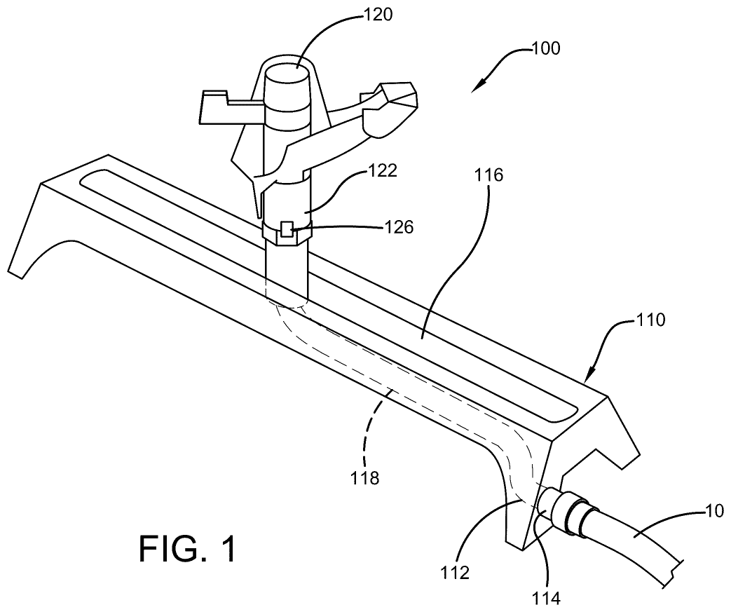

Referring initially to the drawings, FIG. 1 illustrates a perspective view of one potential embodiment of a rotating sprinkler device with movable track 100 of the present invention while a hose 10 is attached to the device 100 in accordance with the disclosed architecture. The device 100 is primarily comprised of a base 110 with at least one sprinkler head 120 that can be moved within the base 110 via at least one track 116 of the base 110. This allows the base 110 to be positioned in one location, but wherein the sprinkler head 120 can be moved within the base 110 to allow different areas of a lawn to be covered.

The base 110 is preferably comprised of a plastic or corrosion-resistant metal material. The base 110 may be any shape but is preferably generally rectangular. In one embodiment, the base 110 is comprised of at least one leg 112. The leg 112 may be any style such as but not limited to a fixed leg, a telescopic leg, a ball and socket leg, etc. that may raise the height of the base 110 and also allow the base 110 to be tilted as needed for specific watering applications.

The base 110 is also comprised of at least one connection point 114. The connection point 114 allows at least one hose 10 to be attached to the base 110. The connection point 114 may be any type of hose 10-connection point known in the art such as but not limited to a quick-connector, a threaded connector, etc. The connection point 114 is in fluid communication with at least one sprinkler head 120 of the device 100 via at least one internal tubing 118 within the base 110 that runs from the connection point 114 to the sprinkler head 120.

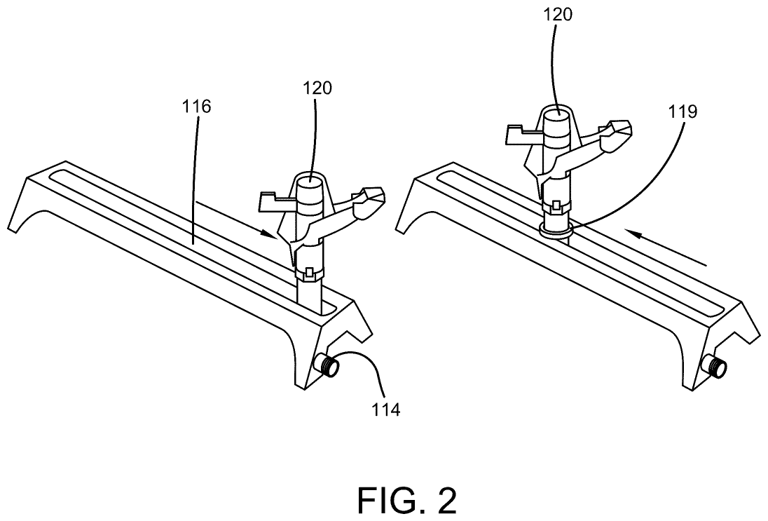

The sprinkler head 120 attaches to the base 110 via at least one track 116. The track 116 is attached within and/or on the base 110. The track 116 may be any type of sliding track style that allows the sprinkler head 120 to remove laterally along the X-axis of the base, as seen in FIG. 2. It should be appreciated that the tubing 118 can also move with the sprinkler head 120 along the track 116. Position of the sprinkler head 120 along the track 116 can be locked at a specific position along the track 116 via at least one locking member 119 such as but not limited to a button, a clip, a clamp, a latch, a ring lock, a twisting lock, a pin, etc.

The sprinkler head 120 may be any type of sprinkler head known in the art. However, the sprinkler head 120 is preferably a rotating sprinkler head that can rotate 360 degrees relative to the Y-axis of the base 110. In this manner, the head 120 can be automatically rotated (via water pressure) or manually rotated to water a desired area of a lawn. In a manually rotated embodiment, the head 120 may be comprised of at least one locking member 126 that locks the rotation of the head 120 in a desired position. The locking member 126 may be any type such as but not limited to a twist lock, a rotating lock, a button lock, a latch, a clip, a pin, etc.

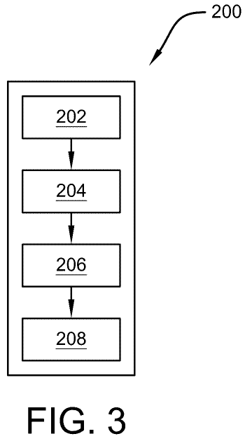

The present invention is also comprised of a method of using 200 the device 100, as seen in FIG. 3. First, a device 100 is provided comprised of a base 110 with at least one track 116, at least one connection point 114, and at least one tubing 118, and at least one sprinkler head 120 attached to the track 116 [Step 202]. Then, a hose 10 can be attached to the connection point 114 [Step 204]. Then, water can be supplied to the device 100 via the hose 10, wherein the water travels from the hose 10, through the connection point 114 and tubing 118 to the sprinkler head 120, and out of the sprinkler head out to the area surrounding the sprinkler head [Step 206]. Next, the sprinkler head 120 can be repositioned along the track 116 as desired to water various areas of an area surrounding the sprinkler head 120 [Step 208].

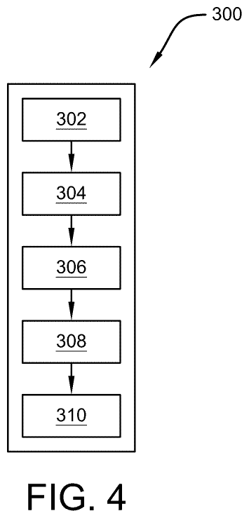

The present invention is also comprised of a method of using 300 the device 100, as seen in FIG. 4. First, a device 100 is provided comprised of a base 110 with at least one leg 112, at least one track 116, at least one connection point 114, and at least one tubing 118, and at least one sprinkler head 120 attached to the track 116 [Step 302]. Then, a hose 10 can be attached to the connection point 114 [Step 304]. Next, a user can adjust the height and/or angle of the leg 112 [Step 306]. Then, water can be supplied to the device 100 via the hose 10, wherein the water travels from the hose 10, through the connection point 114 and tubing 118 to the sprinkler head 120, and out of the sprinkler head out to the area surrounding the sprinkler head [Step 308]. Next, the sprinkler head 120 can be repositioned along the track 116 as desired to water various areas of an area surrounding the sprinkler head 120 [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rotating sprinkler device with movable track” and “device” are interchangeable and refer to the rotating sprinkler device with movable track 100 of the present invention.

Notwithstanding the forgoing, the rotating sprinkler device with movable track 100 of the present invention and its various components can be of any suitable size and configuration as is known in the art without affecting the overall concept of the invention, provided that they accomplish the above-stated objectives. One of ordinary skill in the art will appreciate that the size, configuration, and material of the rotating sprinkler device with movable track 100 as shown in the FIGS. are for illustrative purposes only, and that many other sizes and shapes of the rotating sprinkler device with movable track 100 are well within the scope of the present disclosure. Although the dimensions of the rotating sprinkler device with movable track 100 are important design parameters for user convenience, the rotating sprinkler device with movable track 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rotating sprinkler device with movable track comprising:
a base comprised of a track;
a hose connection point positioned on the base;
a sprinkler head that attaches to the track; and
a tubing that places the hose connection point in fluid communication with the sprinkler head.

2. The rotating sprinkler device with movable track of claim 1, wherein the sprinkler head can rotate 360 degrees relative to a Y-axis of the base.

3. The rotating sprinkler device with movable track of claim 1, wherein the hose connection point is comprised of a quick-connector.

4. The rotating sprinkler device with movable track of claim 1, wherein the hose connection point is comprised of a threaded-connector.

5. The rotating sprinkler device with movable track of claim 1, wherein the sprinkler head can move along the track relative to the X-axis of the base.

6. A rotating sprinkler device with movable track comprising:
a base comprised of a track and a leg;
a hose connection point positioned on the base;
a sprinkler head that attaches to the track; and
a tubing that places the hose connection point in fluid communication with the sprinkler head.

7. The rotating sprinkler device with movable track of claim 6, wherein the sprinkler head can rotate 360 degrees relative to a Y-axis of the base.

8. The rotating sprinkler device with movable track of claim 6, wherein the hose connection point is comprised of a quick-connector.

9. The rotating sprinkler device with movable track of claim 6, wherein the hose connection point is comprised of a threaded connector.

10. The rotating sprinkler device with movable track of claim 6, wherein the sprinkler head can move along the track relative to the X-axis of the base.

11. The rotating sprinkler device with movable track of claim 6, wherein the leg is comprised of a telescopic leg.

12. The rotating sprinkler device with movable track of claim 6, wherein the leg is comprised of a ball and socket leg.

13. The rotating sprinkler device with movable track of claim 6, wherein the sprinkler head is comprised of a locking member.

14. The rotating sprinkler device with movable track of claim 13, wherein the locking member inhibits rotation of the sprinkler head.

15. A method of using a rotating sprinkler device with movable track, the method comprising the following steps:
providing a rotating sprinkler device with movable track comprised of a base comprised of a track, a connection point, and a tubing, and a sprinkler head attached to the track;
attaching a hose to the connection point;
supplying water to the hose; and
repositioning the sprinkler head along the track.

16. The method of using a rotating sprinkler device with movable track of claim 15, wherein the sprinkler head can rotate 360 degrees relative to a Y-axis of the base.

17. The method of using a rotating sprinkler device with movable track of claim 15, wherein the hose connection point is comprised of a quick-connector.

18. The method of using a rotating sprinkler device with movable track of claim 15, wherein the hose connection point is comprised of a threaded connector.

19. The method of using a rotating sprinkler device with movable track of claim 15, wherein the base is comprised of a leg.

20. The method of using a rotating sprinkler device with movable track of claim 19 further comprised of a step of adjusting a height or adjusting an angle of the leg.
